(19) United States
(12) Patent Application Publication
(10) Pub. No.: US 2019/0079967 A1
(43) Pub. Date: Mar. 14, 2019

(54) AGGREGATION AND DEDUPLICATION ENGINE

(71) Applicant: HUDSON CROSSING, LLC, New York, NY (US)

(72) Inventor: George P. Roukas, New York, NY (US)

(73) Assignee: Hudson Crossing, LLC

(21) Appl. No.: 16/128,764

(22) Filed: Sep. 12, 2018

Related U.S. Application Data
(60) Provisional application No. 62/557,275, filed on Sep. 12, 2017.

(51) Int. Cl. G06F 17/30; G06K 9/62; G06Q 30/06; G06N 3/08

(52) U.S. Cl. CPC G06F 17/30371; G06K 9/6201; G06Q 50/12; G06Q 30/0643; G06N 3/08; G06K 9/6256

(57) ABSTRACT

A method includes determining whether one or more first matching rules can be used by a matching engine to match one or more first identifiers included in first data from a first data source to one or more second identifiers in second data from a second data source. When the one or more first matching rules can be used to match the first identifiers to the second identifiers, the first data and the second data are aggregated based on the first matching rules. Otherwise, the first data and second data are processed by a recognition engine to generate one or more second matching rules, and the first data and the second data are aggregated based on the second matching rules. Additionally, a portion of the aggregated first data and second data items may be removed based on a value being optimized to form processed data.

### CROSS-REFERENCE TO RELATED APPLICATIONS

This application claims priority under 35 U.S.C. § 119 to U.S. Provisional Patent Application No. 62/557,275, filed on Sep. 12, 2017, whose entire disclosure is hereby incorporated by reference.

### BACKGROUND

Data may be collected from multiple sources and presented in an aggregated form. For example, an online vendor may aggregate sales offers from different suppliers, and this data may identify attributes of the offered goods or services and terms of the sales offers. The online vendor may then provide the aggregated sales offers for comparison shopping by customers. A travel site is a type of online vender that may aggregate content from the multiple suppliers into a single feed, and customers may use the feed to compare, for example, room pricing at different hotels, pricing for different types of rooms at a single hotel, or room pricing on different dates.

In the context of aggregated hotel room content, while it is relatively straightforward to bring the hotel content together into a site (e.g., to compare offers from different suppliers for certain rooms at a particular hotel), consumers often cannot accurately compare room/amenity differences between suppliers. For example, hotel room content for rooms at a particular hotel may be organized based on room rates, but the content may not identify amenities, additional fees, or services associated within the offers. The result is that shoppers often cannot tell whether they are seeing multiple rates that represent the same hotel product or different products entirely. Thus, consumers may be confused as to whether different priced offers for a particular type of room at a hotel represent pricing differences between the suppliers or differences in services and rooms/amenities or ‘terms’ associated with the different offers.

This confusion causes frustration among consumers, and travel sellers have made little progress in fixing the issue because data from the sources to the aggregator is in textual form that is meant to be read by humans and not by machines, and existing aggregation and deduping systems cannot read those strings, reason out the meaning of each string, and convert the string into machine codes while keeping up with the high-performance systems of travel sellers. Furthermore, existing automated methods for comparing aggregated data, such as data hotel products, may be ineffective and may require substantial manual intervention.

### BRIEF DESCRIPTION OF THE DRAWINGS

The embodiments will be described in detail with reference to the following drawings in which like reference numerals refer to like elements wherein:

FIG. 1 is an overview of principles of an embodiment;

FIG. 2 shows an example hotel rate table for specific check-in/check-out dates according to an embodiment;

FIG. 3 shows an example of an aggregation and deduplication engine according to an embodiment;

FIG. 4 shows an aggregation and deduplication process according to an embodiment;

FIG. 5 is a diagram of example components of device that may be included in certain components according to an embodiment; and

FIGS. 6-11 provide examples according to embodiments described herein.

### DETAILED DESCRIPTION

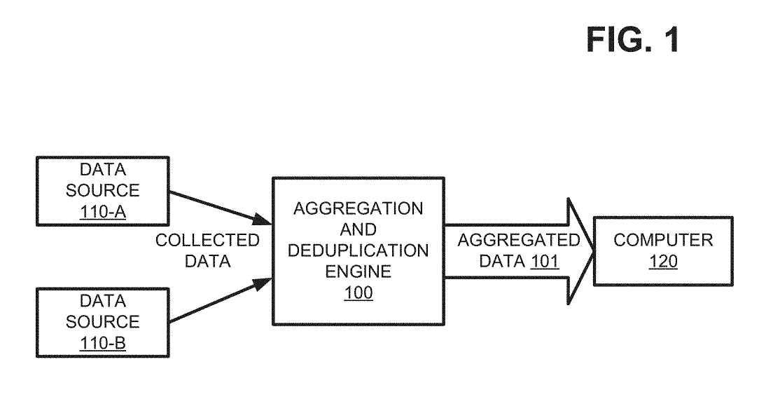

FIG. 1 illustrates an overview according of an embodiment. In FIG. 1, an aggregation and deduplication (A&D) engine 100 may receive data from multiple sources 110-A and 110-B (referred to individually as data source 110 and collectively as data sources 110). In a particular example, the data may be associated with different hotel room products offered by respective suppliers associated with the data sources 110. For example, data from the first source 110-A may be associated with hotel room products offered by a first supplier (e.g., a hotel chain), and data from the second source 110-B may be associated with hotel room products offered by a second supplier (e.g., a wholesaler). In another configuration, the data from the sources 110 may be collected by a third party (e.g., a vendor associated with server 120), and the A&D engine 100 may function to process and organize the collected data for easier consumption by consumers.

In another example, data from online vendors may relate to offers for sales of goods or service, and the data may include prices and may identifying attributes of the goods or services. For example, the data such as a vehicle identification number (VIN) may identify a type of car, but does not tell a consumer which add-ons are installed even though these add-ones may substantially affect the price of the vehicle.

In the context of hotel rooms, the different room products may have different associated prices (also referred to as room rates). The room rates for the different room products may vary based on, for example, the selected hotel, the selected types of room, the dates selected, a desired length of stay, and various pricing control conditions implemented by the hotel. In more detail, the hotel room products at a hotel may represent combinations of different room types and rate plans, and may have associated prices for a particular time.

As used herein, the room types may represent collections of attributes related to the hotel room being rented, such as square footage, a view quality, bed types, etc. More generally, the room types may correspond to fixed attributes of a hotel room. Typically, a hotel may include a relatively small number (e.g., less than 100) of room types since room types are associated with generally fixed attributes.

In contrast, the rate plans identify collections of other attributes that are independent of the room itself and may represent various inclusions associated with the hotel room, such as services (e.g., whether wireless internet access or parking is provided), goods (e.g., whether breakfast or other meal is provided), contractual terms (e.g., cancellation rules and fees), etc. More generally, the rate plans may correspond to changeable attributes associated with renting a hotel room. Since the rate plans may vary, the data from each of the sources 110 may relate to a relatively large number (e.g., hundreds or thousands) of possible different combinations of room rates for a given hotel. Furthermore, the rate plans for a data source may continuously vary over time.

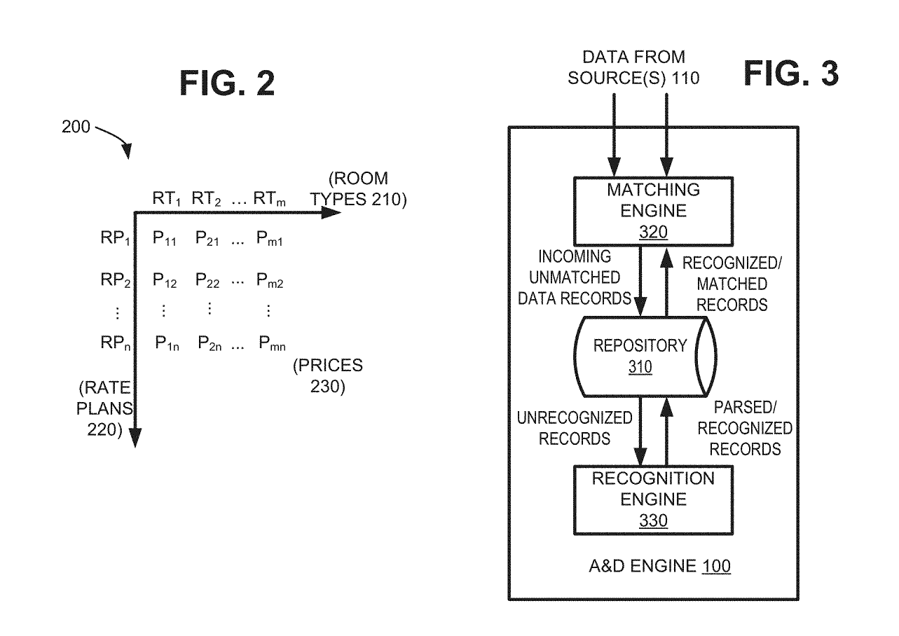

Thus, the data received by the A&D engine 100 may represent respective hotel products representing combinations of room types and rate plans offered by the sources 110-A and 110-B. For example, FIG. 2 provides an example of a rate table 200 that may be received from a data source 110 for a given hotel on a given date. For example, given specific check-in and check-out dates, the rate table 200 may identify different room types (RT₁, . . . , RTₘ) 210 and different rate plans (RP₁, . . . , RPₙ) 220. The rate table 200 may further identify different prices (P₁₁, . . . , Pₘₙ) 230 associated with the various combinations of room types 210 and rate plans 220. Different data sources 110-A, 110-B may provide different rate tables 200 that include data associated with different room types 210, rate plans 220, and/or prices 230.

The data received from a data source 110 may include various alphanumeric and/or symbol strings or other data identifying the room types 210 and the rate plans 220 for the room products from that data source 110. Furthermore, the data identifying the room types 210 and the rate plans 220 may typically vary for each of the different data source 110. For example, the first data source 110-A may use a code “2DB” to identify a room with two double beds, while the second data source 110-B may use a code “DB/DB” to identify this room type. While this example uses codes based on characters associated with textual descriptions of the room type, identifiers for room types or rate plans included in data from a data source 110 in other examples may be entirely unrelated to text-based descriptions, such that the identifiers cannot be easily interpreted or translated. For example, attributes may be identified using proprietary internal codes and programming symbols. Furthermore, the descriptors for room types or rate plans may vary over time, such as adding new identifiers for the new and/or changed rate plans.

While various components of an example of the rate table 200 are shown in FIG. 2, it should be appreciated that the rate table 200 may include additional, fewer, or different elements. For example, the rate table 200 may further identify other pricing factors, such as eligibility rules for certain room prices (e.g., membership in a hotel loyalty program) so that different rate tables 200 or different portions of a same rate table 200 may be used for different customers based on attributes of those customers.

Returning to FIG. 1, the A&D engine 100 may process the received data to enable efficient access by a user, such as identifying and grouping similar data for easier access and comparison by a user. For example, as described below, the A&D engine 100 may parse the received data from a data source 110 to locate identifying terms associate with respective room types 210 and rate plans 220 for each room price 230 from the data source 110. For example, the A&D engine 100 may include a learning module that builds a repository that associates first identifiers used for room types 210 and rate plans 220 by a first data source 110-A with second identifiers used for room types 210 and rate plans 220 by a second data source 110-B. The learning module may be deep learning neural network that learns how each supplier describes hotels, room types, and rate plans and categorizes the results. For example, the learning module may generate the repository of matching rules using training data, such as prior offers from the data source 110 or data from the data source 110 identifying how certain room types or rate plans are described.

The A&D engine 100 may also include a matching engine that attempts to match room offers in received data based on the matching rules stored in the repository. If one or more of the offers in received data for the data source 110 cannot be processed using the matching rules in the repository, these unmatched offers may be sent to the learning module for additional processing, such as to match attributes in these offers with other offers using the deep learning neural network. In this way, the matching engine may quickly match certain room types and rate plans with less processing, and the learning engine may perform additional processing on the unmatched data to determine matching room types and/or rate plans with minimal manual input and at significantly higher speed than other methods.

The A&D engine 100 may then aggregate matched data from the different data sources 110 to form aggregated data 101. As used herein, aggregation by the A&D engine 100 may generally refer to a process of bringing in information from multiple sources and accurately matching items across sources. For example, A&D engine 100 may identify and group room rates from different data sources 110-A and 110-B that are associated with a similar combination of room type 210 and rate plan 220.

In one example, the A&D engine 100 may add data, such as alphanumeric characters or symbols to designate matching room offers associated with similar room types and/or rate plans. In another example, A&D engine 100 may organize the aggregated data 101 as a list, table, or other data structure that groups, positions, or otherwise identifies the matching data. For instance, the aggregated data 101 may be a list that sorted or otherwise encoded to position together matching data from the different sources 100 when displayed. In another example, the A&D engine 100 may encode the aggregated data 101 such that matching data (e.g., similar room offers) shares a color, font, or other graphical characteristic when displayed.

When forming the aggregated data 101, the A&D engine 100 may further remove one or more of the matched data of the sources 110-A, 110-B to prevent the aggregated data from being excessively voluminous or otherwise confusing to a user. As used herein, deduplication (or deduping) may generally refer to a process of scanning for duplicate items, once properly matched in the aggregation process, to select an item that best matches some value being optimized, like finding the lowest price. For example, the A&D engine 100 may remove or hide (e.g., add code to cause to not be displayed) data associated with one or more high priced room offers for matching data associated with similar room types 210 and rate plans 220.

The A&D engine 100 may forward the aggregated data 101 to a computer 120 for distribution to customers or other users. For example, the computer 120 may function as a server that provides content based on the aggregated data 101. In another example, the computer 120 may forward the aggregated data to an application executed on user devices associated with the customers.

While various components of an environment are shown in FIG. 1, it should be appreciated that additional, fewer, or different components may be included. For example, the environment may include a computing device that performs preprocessing of data from the data sources 110 before processing by the A&D engine 100.

FIG. 3 shows that the A&D engine 100 may include a repository 310, a matching engine 320, and a recognition engine 330. The repository 310 may store matching instructions to match data from different sources 110. As described below, records come in from the suppliers 110, and the matching engine 320 examine each record and see if it's in a preprocessed shopping file in the repository 310. If it is, the matching engine 320 can match it directly and can go to the next record. If it's not, the unmatched record is sent it to the recognition engine 330, where the information is parsed and returned to the repository 310. When the A&D engine 100 has gone through all the records, the A&D engine 100 can then do the matching and dedupe the records that do not optimize a factor to be optimized, such as the lowest price.

For example, the matching engine 320 may function to match a particular product to other products when the repository 310 includes matching instructions for that type of product. The matching engine 320 may match and reject properties and products by comparing descriptions of the room and room rate based on the matching instructions in the repository 310. When the room/rate products from one supplier match other room/rate products from another supplier, the matching engine 320 may use the matches for comparison and deduping. For example, the matching engine 320 may group together matching products related to similar rooms types and rate plans and remove one or more duplicate products in the group.

Otherwise, when the matching engine 320 determines that data for a product cannot be handled based on the matching instructions in the repository 310, data for this product may be forwarded to the recognition engine 330 for additional processing. The recognition engine 330 may function to develop new matching instructions, such as handling new products that do not match any previously identified product. This configuration may help to improve performance by vastly reducing the overhead of the matching engine 320.

The recognition engine 330 may process the product offers that cannot be matched by the matching engine 320 using the stored data in the repository 310 to learn how each supplier describes hotels, room types, and rate plans and to categorize the results. For example, the recognition engine may parse the received data to identify terms or phrases used in a textual description of the room product and may analyze these terms to determine associated room types and rate plans. As previously described, the rate plans may vary significantly among suppliers and even at a same supplier over time, and the rate plans may be identified by recognition engine 330 parsing terms or groups of terms in the received offers and processing the meaning of these terms/phrases to determine their likely meanings. The recognition engine 330 may then update the repository 310 with the parsed/recognized record to form new matching rules. Thus, any items that have no matching instructions in the repository 310 may be parsed and recognized through the recognition engine 330 for categorization and fed back to the matching engine 320.

In one example, when the recognition engine 330 cannot parse a record from a supplier after processing, the recognition engine 330 may store the record (in log file). A user may attempt to manually parse the record, and if the user is successful, the manually parsed file may be returned to the recognition engine 330 as a training record. If the user also cannot parse the record, the record is marked as a bad record. Thereafter, each subsequent time that bad record is received (or a substantially identical record that is more than a threshold amount similar to the bad record (e.g., more than 95% identical)), the marked, bad record may be discarded.

The recognition engine 330 may further receive and process training data in an up-front training process that provides the initial matching instructions for the repository 310. For example, the recognition engine 330 may analyze prior offers by a supplier to determine matching rules for that supplier.

The two part structure of the A&D engine 100 greatly reduces the overhead of the matching engine 320 and provides significantly greater throughput by the matching engine 320. In the context of hotel data, the structure of the input (matching) data may tend to be relatively fixed across a set of relevant attributes such that a ratio of non-matched items is relatively low and most of the aggregated data may be processed efficiently and quickly by the matching engine 320.

In one example, the recognition engine 330 may be implemented as a deep learning neural network. Deep learning is a class of machine learning algorithms that use a cascade of multiple layers of nonlinear processing units for feature extraction and transformation. Each successive layer uses the output from the previous layer as input. The deep learning may function to learn multiple levels of representations that correspond to different levels of abstraction that form a hierarchy of concepts used to define the matching rules stored in the repository 320.

Deep learning models may be based on an artificial neural network. In deep learning, each level learns to transform its input data into a slightly more abstract and composite representation. A deep learning process can learn which features to optimally place in which level on its own. The numbers of layers and layer sizes may be varied to provide different degrees of abstraction. For example, the recognition engine 330 may be embodied as a deep convolutional neural network for classification, such as AlexNet, GoogLeNet, or other deep learning algorithm.

In one example, the deep learning associated with the recognition engine 330 may be implemented as an artificial neural network (ANN) that learns to perform tasks by considering examples, generally without being programmed with any task-specific rules by automatically generating identifying characteristics from the learning material being processed. An ANN is based on a collection of connected units or nodes, and each connection can transmit a signal from between node. In another example, the recognition engine 330 may include a deep neural network (DNN), which is a feed-forward deep neural network with multiple fully connected (FC) layers.

A node in a neural network may receive and process a signal, and then forward the processed signal to other connected nodes. The connections between nodes are called ‘edges’. The nodes and edges typically have a weight that adjusts as learning proceeds, and the weight may change the strength of the signal at a connection. The nodes may have a threshold such that the signal is only sent if the aggregate signal satisfies the threshold. Typically, artificial neurons are aggregated into layers that perform different kinds of transformations on their inputs. Signals travel from the first layer (the input layer) to the last layer (the output layer) and may possibly traverse the layers multiple times.

In one example, the matching engine 320 and/or the recognition engine 330 may be implemented as a distributed network using multiple computing devices, multiple processors in a computing device, and/or multiple cores in a processor. The processing load may be selectively allocated to the matching engine 320 and/or the recognition engine 330 based on the operation being performed. For example, substantially all of the distributed processing capability may be initially allocated to the recognition engine 330 when processing the training data, and then substantially all of the distributed processing capability may be re-allocated to the matching engine 320 after training to process new data using the matching rules. Subsequently, when the matching engine 320 cannot process a portion of the received data based on the stored matching rules in the repository 310, a portion of processing capability assigned to the matching engine 320 may be re-allocated back to the recognition engine 330 to perform additional processing to develop new matching rules. The amount of the processing capability reallocated from the matching engine 320 to the recognition engine 330 may vary based on the amount of data to be processed by the recognition engine 330.

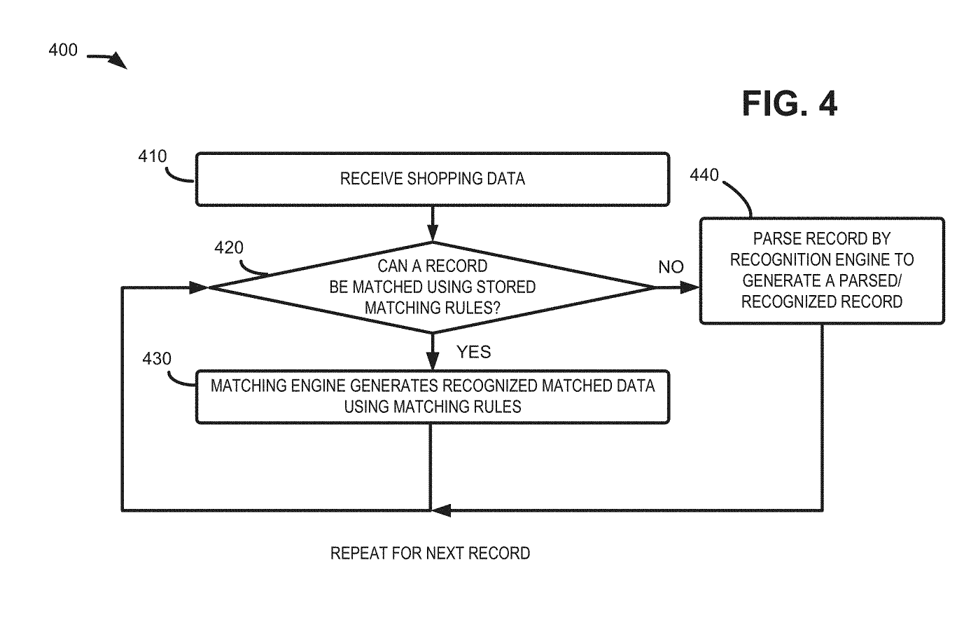

FIG. 4 shows an aggregation and deduplication process 400 according to one implementation. In the following description, the aggregation and deduplication process 400 is described as being performed by components of the A&D engine 100, such as the matching engine 320 and the recognition engine 330. However, it should be appreciated that one or more portions of the aggregation and deduplication process 400 may be performed by other components, such as by one of the data sources 110 or the computer 120.

As shown in FIG. 4, the aggregation and deduplication process 400 may include the matching engine 320 receiving data (step 410), such as new offers by a supplier 110, and determining whether a record in the received data can be processed using the matching rules stored in the repository 310 (step 420). For example, the matching engine 320 may periodically (e.g., hourly) receive or download data from the data suppliers 110 and compare this data with prior received data to determine new/changed room offers. The matching engine 320 can then determine whether the data (e.g., identifiers) in the offers can be matched using the matching rules in the repository 310.

If record of the received data can be processed using the matching rules stored in the repository 310 (step 420—YES), the matching engine 320 processes this portion of the received data using the matching rules to form a recognized/matched record based on the matching rules (step 430), such as to group offers related to substantially similar room types and rate plans.

The matching engine 320 may also aggregate and deduplicate the recognized/matched offers in step 430. For example, matching engine 320 may remove one or more of the offers based on their prices or other variable being maximized.

If a record in the received data cannot be processed using the matching rules stored in the repository 310 (step 420—NO), that record may be parsed by the recognition engine 330 to recognize matches and to generate new matching rules stored in the repository (step 440). For example, the matching engine 320 may determine that a portion of the received data cannot be processed using the matching rules stored in the repository 310 in step 440 when the matching engine 320 cannot processes this portion of the received data within a threshold length of time and/or when processing by the matching engine 320 produces more than a threshold quantity of errors.

The recognition engine 330 may process the data to generate new matching rules in step 440 using a deep learning. For example, the recognition engine 330 may implement a deep learning neural network to identify room types and rate plans offered by a data source 110. In one implementation, the recognition engine 330 may use decisions trees to select a most likely room type or rate plan associated with an identifier in a description of the room/rate product. For example, the recognition engine 330 may look to characters or symbols used in the identifier, the position of the identifier relative to other data (e.g., looking to a grammar or structure of the description), other identifiers used by the supplier, identifiers used by other suppliers, etc. For example, the recognition engine 330 may determine that a first identifier used by a first supplier may match a second identifier that is used by a second supplier and shares similar characters. The recognition engine 330 may determine, for example, that the first data source 110-A uses a first code (e.g., “2DB”) and the second data source 110-B uses a second, different code (e.g., “DB/DB”) to identify a room with two double beds.

In another example, the recognition engine 330 may determine that an identifier used by a supplier likely does not correspond to a room type or rate plan attribute already associated with another identifier used by that supplier. In another example, the recognition engine 330 may be programmed to know that certain room or rate plan attributes are always associated with room products for certain suppliers, such as the recognition engine 330 being programmed to know that a certain supplier only offers hotel rooms that are not cancelable and must be prepaid or includes a booking fee, even if this information is not included in the record.

The matching is then done on all of the room type and rate plan attributes together, not each individually, so that learning occurs on an individual attribute basis but the matching is on all attributes in the record.

After the record is matched by the matching engine based on stored matching rules in step 430 or parsed by the recognition engine in step 440, the process 400 then returns to step 420, in which the matching engine 320 attempts to match another record using the matching rules stored in repository 310.

While FIG. 4 shows the aggregation and deduplication process 400 as including certain actions, it should be appreciated that the aggregation and deduplication process 400 may include different, fewer, or additional actions. For example, the aggregation and deduplication process 400 may include an error checking step in which incomplete or damaged data is removed or repaired before processing. Furthermore, it should be appreciated that the actions in the aggregation and deduplication process 400 may be performed in a different order.

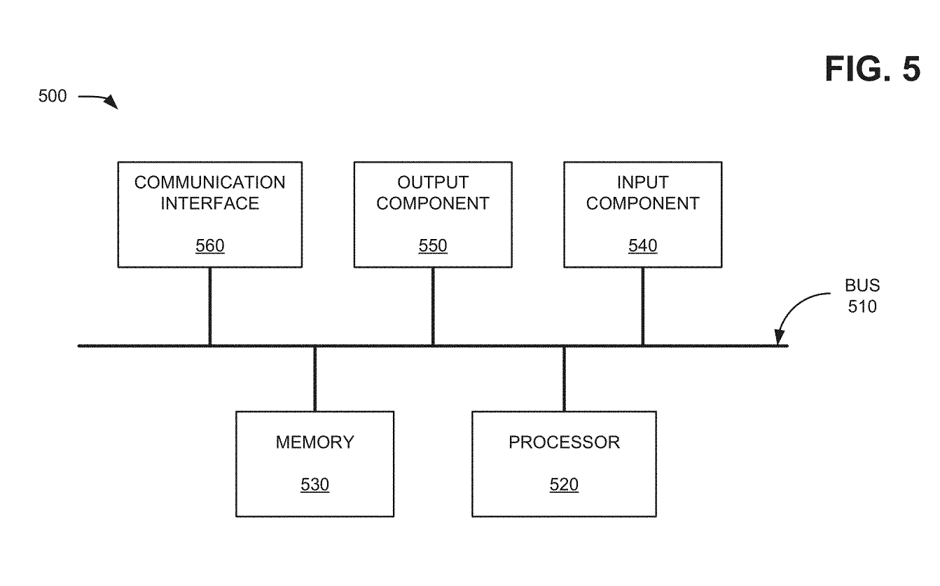

FIG. 5 is a diagram showing components of a device 500 in one embodiment. Each of the devices described above (e.g., data sources 110, computer 120, repository 310, matching engine 320, recognition engine 330, etc.) may include one or more devices 500. Device 500 may include a bus 510, a processor 520, a memory 530, an input component 540, an output component 550, and a communication interface 560.

Bus 510 may include one or more communication paths that permit communication among the components of device 500. Processor 520 may include a processor, microprocessor, or processing logic that may interpret and execute instructions. Memory 530 may include any type of dynamic storage device that may store information and instructions for execution by processor 520, and/or any type of non-volatile storage device that may store information for use by processor 520.

Input component 540 may include a mechanism that permits an operator to input information to device 500, such as a keyboard, a keypad, a button, a switch, etc. Output component 550 may include a mechanism that outputs information to the operator, such as a display, a speaker, one or more light emitting diodes (“LEDs”), etc.

Communication interface 560 may include any transceiver-like mechanism that enables device 500 to communicate with other devices and/or systems. For example, communication interface 560 may include an Ethernet interface, an optical interface, a coaxial interface, or the like. Communication interface 560 may include a wireless communication device, such as an infrared (“IR”) receiver, a Bluetooth® radio, WiFi® circuitry, etc. The wireless communication device may be coupled to an external device, such as a remote control, a wireless keyboard, a mobile telephone, etc. In some embodiments, device 500 may include more than one communication interface 560. For instance, device 500 may include an optical interface and an Ethernet interface.

Device 500 may perform certain operations relating to one or more processes described above in FIG. 4. Device 500 may perform these operations in response to processor 520 executing software instructions stored in a computer-readable medium, such as memory 530. A computer-readable medium may be defined as a non-transitory memory device. A memory device may include space within a single physical memory device or spread across multiple physical memory devices. The software instructions may be read into memory 530 from another computer-readable medium or from another device. The software instructions stored in memory 530 may cause processor 520 to perform processes described herein. Alternatively, hardwired circuitry may be used in place of or in combination with software instructions to implement processes described herein. Thus, implementations described herein are not limited to any specific combination of hardware circuitry and software.

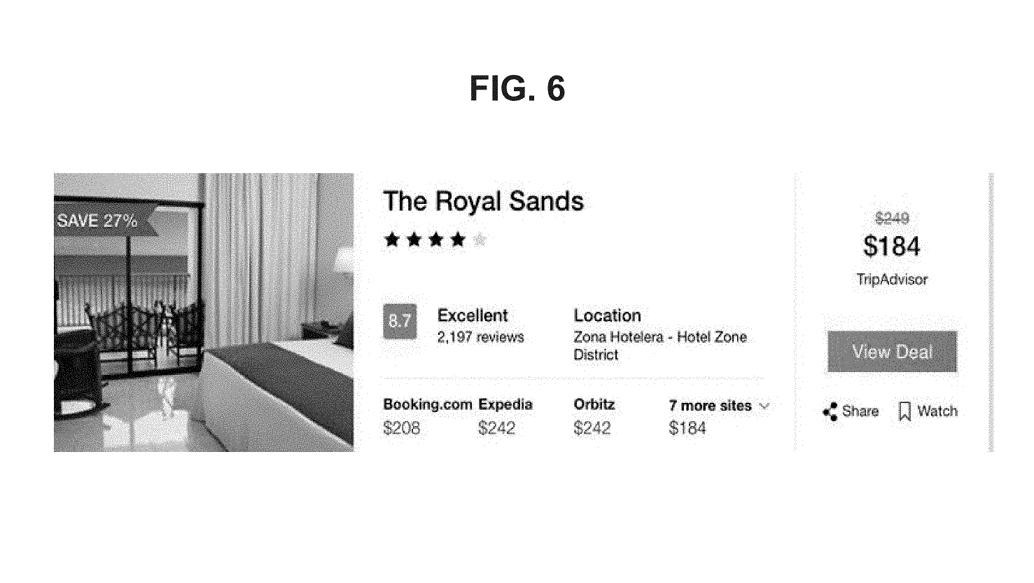

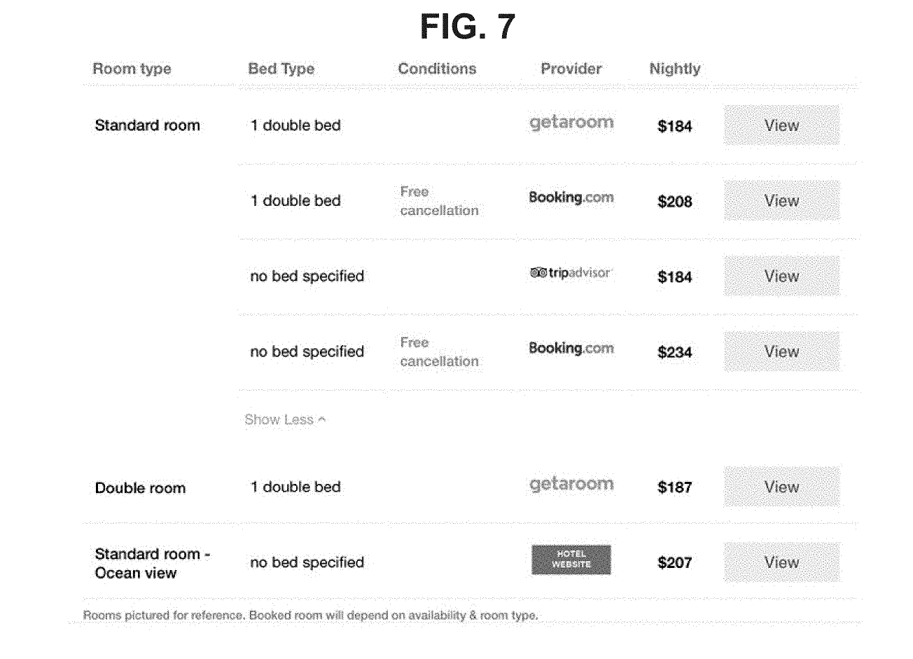

An example in accordance with certain embodiments will now be described. FIGS. 6-9 show an example of what a consumer might see on the sites of two very popular aggregators. In the example, the consumer is shopping for a four night stay at a hotel chosen from the top-level display, the Royal Sands® in Cancun, Mexico. In the example screen shown in FIG. 6, prices may vary from $184 to $242 per night across 9 sources.

If the consumer clicks on or otherwise selects the hotel name, additional details may be presented, as shown in FIG. 7. The consumer is still on the top-level (Kayak®) site shown in FIG. 7, and this view shows three room types: standard, double, and ocean view and that the prices vary significantly. In the display of FIG. 7, both the standard room and the double room have double beds, and the variance in the prices provide the only clue that two of the offers include free cancellation (a rate plan attribute.)

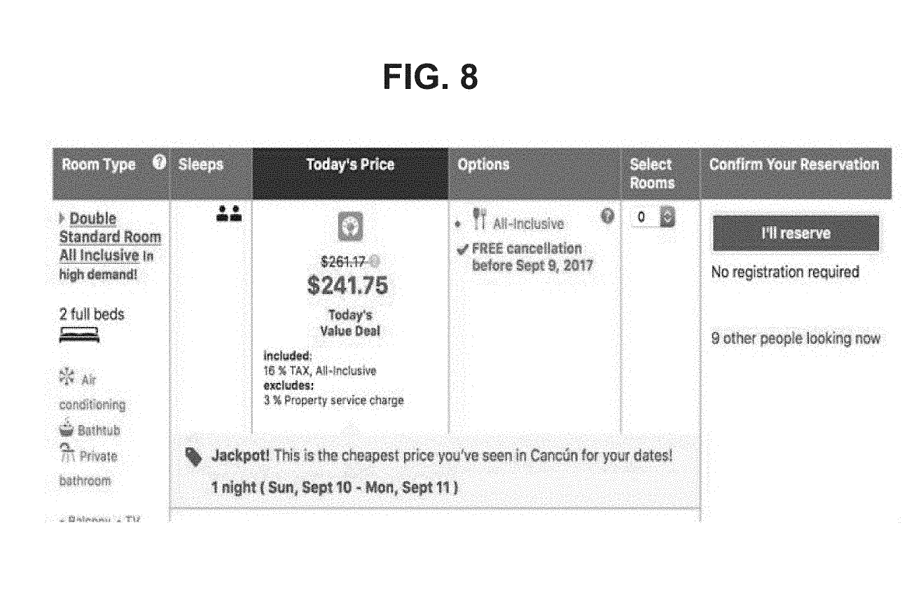

If a consumer clicks on the most expensive option at $234 (with no bedding type specified) for further investigation, the consumer receives additional data as shown in FIG. 8. This additional data shown in the interface of FIG. 8 reveals that the most expensive option is, as with the other offers, for a double standard room.

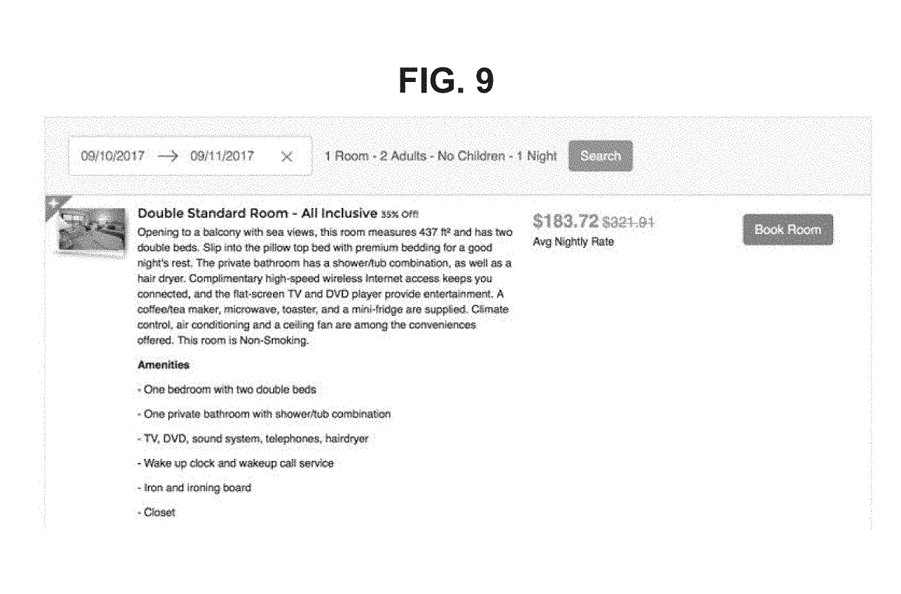

Going back one level to investigate the least expensive option at $184, the consumer may receive the description on the online travel site shown in FIG. 9 when the least expensive option is selected. The additional data reveals that the least expensive room option, too, is a double standard room. So the highest and lowest priced rooms appear differently in the higher level display but represent the same standard double room. Because neither Kayak® nor Booking.com® have accurate aggregation and deduping, there is no way to know this product similarity without manual investigation to collect and correlate data from multiple sources.

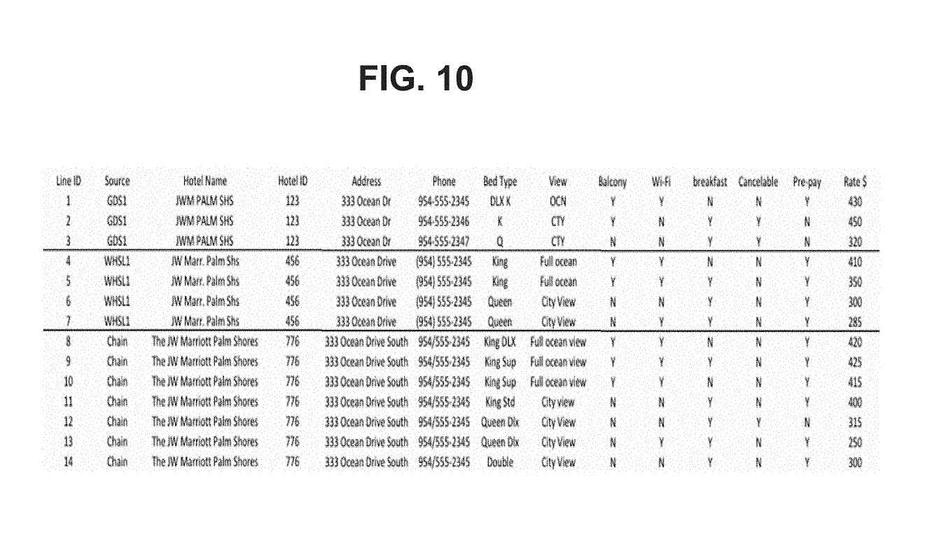

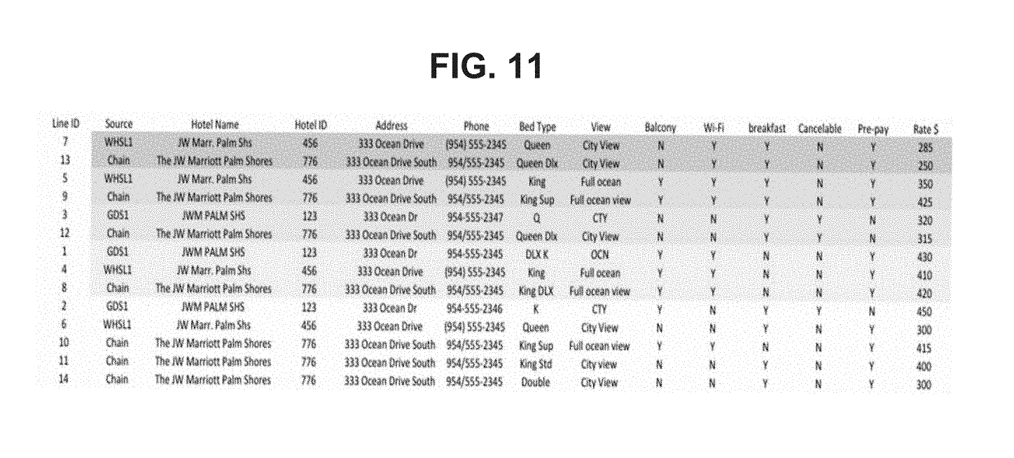

Another example shown in FIGS. 10-11 looks at a single property with rooms and rates offered from three different sources. One is the hotel chain itself, the second is a Global Distribution System (GDS,) and the third is a wholesaler. FIG. 10 shows a table representing how the data might look as it arrives to the matching engine 320. In a real situation, there would be many hotels and many more attributes than the ones listed, but the principle is the same. As the matching engine 320 looks at the incoming information in FIG. 10, it matches these items to database of hotel and room data in repository 310 and observes that some of the items represent the same product.

A modified table in which the matching lines are grouped and highlighted in a single color is shown in the table shown in FIG. 11. The matching engine 320 may then pass this information, grouped by product (e.g., by color) so that the distributor or traveler making the request can compare prices and find the lowest price for the product he wants. In another example, the matching engine may forward a subset of the processed data, such as to identify a lowest-priced one of each different product (e.g., the lowest-priced items in each group of colors).

Accordingly, aspects of the present application can reliably match at the property and the product level. The complete process, for an agency or entity that receives duplicate hotel information from multiple suppliers is divided into two separate functions that operate asynchronously: one function to match a product to other products based on matching instructions, and a second function to develop and specify the matching instructions, such as to handle new products that do not match any previously identified product; this configuration improves performance by vastly reducing the overhead of the first component, the matching engine and provides significantly greater throughput. Furthermore, when the structure of the input (matching) data is relatively fixed across a set of relevant attributes, the ratio of non-matched items is low and allows the two-part design to be viable.

Although described herein with respect to hotel room rates, it should be appreciated that the A&D engine 100 described herein may be used for other applications, such as processing car rental offers to compare products representing different vehicles and attributes, such as insurance and fuel costs or processing offers from online vendors to compare different products presenting goods and related attributes, such as return costs and policies, warranty periods, delivery fees, etc.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks have been described with regard to FIG. 4, the order of the signals may be modified in other implementations. Further, non-dependent signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes, as may be appropriate for the situation and type of information. Storage and use of personal information may be in an appropriately secure manner reflective of the type of information (e.g., through various encryption and anonymization techniques for particularly sensitive information).

Some implementations described herein may be described in conjunction with thresholds. The term “greater than” (or similar terms), as used herein to describe a relationship of a value to a threshold, may be used interchangeably with the term “greater than or equal to” (or similar terms), unless a distinction is made herein that makes such an interpretation indefinite or inaccurate. Similarly, the term “less than” (or similar terms), as used herein to describe a relationship of a value to a threshold, may be used interchangeably with the term “less than or equal to” (or similar terms), unless a distinction is made herein that makes such an interpretation indefinite or inaccurate. As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
collecting first data from a first data source;
determining whether one or more first matching rules can be used by a matching engine to match one or more first identifiers included in the first data to one or more second identifiers in second data from a second data source;
when the one or more first matching rules can be used to match the first identifiers to the second identifiers, aggregating portions of the first data and the second data based on the first matching rules;
when the one or more first matching rules cannot be used to match the first identifiers to the second identifiers, processing at least one of the first data and second data by a recognition engine to generate one or more second matching rules, and aggregating the first data and the second data based on the second matching rules;
removing a portion of the aggregated first data and second data items based on a value being optimized to form processed data; and
forwarding the processed data to another device.

2. The method of claim 1, further comprising processing training data by the recognition engine to generate the first matching rules.

3. The method of claim 2, wherein the training data includes data previously received from at least one of the first data source or the second data source.

4. The method of claim 1, wherein the recognition engine is a deep learning neural network.

5. The method of claim 1, wherein the first data and the second data relate to hotel room rates, and the first matching rules and the second matching rules identify matching room types attributes and matching rate plans attributes.

6. The method of claim 5, wherein aggregating the first data and the second data includes grouping portions of the first data and the second data associated with the matching room types attributes and the matching rate plans attributes.

7. The method of claim 6, wherein removing the portion of the aggregated first data and second data items includes removing a part of a matching portion of the first data and the second data associated with a highest rate.

8. The method of claim 1, wherein aggregating the first data and the second data includes generating a data structure that groups a matching portion of the first data and the second data.

9. The method of claim 1, wherein aggregating the first data and the second data includes inserting code that causes a matching portion of the first data and the second data to be displayed with a common color.

10. The method of claim 1, wherein processing the first data and second data by the recognition engine to generate the one or more second matching rules includes determining that a string of characters included in the first data corresponds to a second string of characters included in the second data.

11. A device comprising:
a memory to store instructions; and
a processor that executes the instructions to:
collect first data from a first data source;
determine whether one or more first matching rules can be used by a matching engine to match one or more first identifiers included in the first data to one or more second identifiers in second data from a second data source;
when the one or more first matching rules can be used to match the first identifiers to the second identifiers, aggregate portions of the first data and the second data based on the first matching rules;
when the one or more first matching rules cannot be used to match the first identifiers to the second identifiers, process at least one of the first data and second data by a recognition engine to generate one or more second matching rules, and aggregate the first data and the second data based on the second matching rules;
remove a portion of the aggregated first data and second data items based on a value being optimized to form processed data; and
forward the processed data to another device.

12. The device of claim 11, wherein the processor further processes training data by the recognition engine to generate the first matching rules.

13. The device of claim 12, wherein the training data includes data previously received from at least one of the first data source or the second data source.

14. The device of claim 11, wherein the recognition engine is a deep learning neural network.

15. The device of claim 11, wherein the first data and the second data relate to hotel room rates, and the first matching rules and the second matching rules identify matching room types attributes and matching rate plans attributes.

16. The device of claim 15, wherein the processor, when aggregating the first data and the second data, further groups portions of the first data and the second data associated with the matching room types attributes and the matching rate plans attributes.

17. The device of claim 16, wherein the processor, when removing the portion of the aggregated first data and second data items, removes a part of a matching portion of the first data and the second data associated with a highest rate.

18. The device of claim 11, wherein the processor, when aggregating the first data and the second data, further generate a data structure that groups a matching portion of the first data and the second data.

19. The device of claim 11, wherein the processor, when aggregating the first data and the second data, inserts code that causes a matching portion of the first data and the second data to be displayed with a common color.

20. The device of claim 11, wherein the processor, when processing the first data and second data by the recognition engine to generate the one or more second matching rules, further determines that a string of characters included in the first data corresponds to a second string of characters included in the second data.
